(19) United States
(12) Patent Application Publication
(10) Pub. No.: US 2026/0194751 A1
(43) Pub. Date: Jul. 9, 2026

(54) MULTI-DIRECTIONAL REFLECTIVE INCOUPLER AND SPLIT EXIT PUPIL EXPANDER TO REDUCE LENS SIZE

(71) Applicant: GOOGLE LLC, Mountain View, CA (US)

(72) Inventors: Daniel Adema, Kitchener (CA); Shreyas Potnis, Kitchener (CA)

(21) Appl. No.: 18/863,912

(22) PCT Filed: May 11, 2023
(86) PCT No.: PCT/US2023/021796

§ 371 Date: Nov. 7, 2024

Related U.S. Application Data
(60) Provisional application No. 63/341,731, filed on May 13, 2022.

(51) Int. Cl. G02B 27/01

(52) U.S. Cl. CPC G02B 27/0172; G02B 2027/0123

(57) ABSTRACT

A waveguide combiner includes an incoupler, an outcoupler, and a plurality of exit pupil expanders. The incoupler is configured to split incoming display light into multiple light beams. Each exit pupil expander of the plurality of exit pupil expanders includes one or more facets configured to receive a corresponding light beam of the multiple light beams and to output light towards the outcoupler based on the received corresponding light beam.

### BACKGROUND

In near-to-eye display (NED) devices (e.g., augmented reality glasses, mixed reality glasses, virtual reality headsets, and the like), light from an image source is generally coupled into, for example, a waveguide-based optical combiner (also referred to herein as a “waveguide combiner”) by an optical input coupling element, such as an in-coupling grating (i.e., an ““incoupler”). The incoupler can be formed on a surface, or multiple surfaces, of the waveguide combiner or disposed within the waveguide combiner. Once the light beams have been coupled into the waveguide combiner, the light beams are “guided” through the waveguide combiner, typically by multiple instances of total internal reflection (TIR) or by a coated surface(s). The guided light beams are then directed out of the waveguide combiner by an output optical coupling (i.e., an “outcoupler”), which can also take the form of an optical grating. The outcoupler directs the light at an eye-relief distance from the waveguide combiner, forming an exit pupil within which a virtual image generated by the image source can be viewed by a user of the display device. In many instances, an exit pupil expander, which can also take the form of an optical grating, is arranged in an intermediate stage between the incoupler and outcoupler to receive light that is coupled into the waveguide combiner by the incoupler, expand the light, and redirect the light towards the outcoupler.

### SUMMARY OF EMBODIMENTS

In accordance with one aspect, a waveguide combiner includes an incoupler, an outcoupler, and a plurality of exit pupil expanders. The incoupler is configured to split incoming display light into multiple light beams. Each exit pupil expander of the plurality of exit pupil expanders includes one or more facets configured to receive a corresponding light beam of the multiple light beams and to output light towards the outcoupler based on the received corresponding light beam.

In at least some embodiments, the one or more facets each comprise a partially reflective coating.

In at least some embodiments, the incoupler includes a plurality of partially reflective mirrors, each partially reflective mirror of the plurality of partially reflective mirrors is configured to generate one light beam of the multiple light beams.

In at least some embodiments, a first partially reflective mirror of the plurality of partially reflective mirrors is configured to reflect a first light beam of the multiple light beams to a first exit pupil expander of the plurality of exit pupil expanders.

In at least some embodiments, a first partially reflective mirror of the plurality of partially reflective mirrors is configured to direct a second light beam of the multiple light beams to a second partially reflective mirror (of the plurality of partially reflective mirrors.

In at least some embodiments, the partially reflective mirror of the plurality of partially reflective mirrors is configured to reflect the second light beam to a second exit pupil expander of the plurality of exit pupil expanders.

In at least some embodiments, a first exit pupil expander (606-1) of the plurality of exit pupil expanders comprises a first facet configured to split the corresponding light beam received by the first exit pupil expander into a first light beam and a second light beam, direct the first light beam to the outcoupler, and direct the second light beam to a second facet of the first exit pupil expander.

In at least some embodiments, a second exit pupil expander of the plurality of exit pupil expanders includes a first facet configured to split the corresponding light beam received by the second exit pupil expander into a third light beam and a fourth light beam, direct the third light beam to the outcoupler, and direct the fourth light beam to a second facet of the second exit pupil expander.

In at least some embodiments, the incoupler includes a polarizing beam splitter configured to generate a first light beam of the multiple light beams having a first polarization, a mirror configured to generate a second light beam of the multiple light beams having a second polarization, and a half-wave plate configured to convert the second polarization of the second light beam to the first polarization.

In at least some embodiments, the polarizing beam splitter is configured to direct the first light beam to a first exit pupil expander (606-1) of the plurality of exit pupil expanders, the mirror is configured to direct the second light beam to the half-wave plate, and the half-wave plate is configured to direct the second light beam to a second exit pupil expander of the plurality of exit pupil expanders.

In at least some embodiments, the first polarization is an S-polarization and the second polarization is a P-polarization.

In accordance with one aspect, a waveguide combiner includes an incoupler, a first exit pupil expander, a second exit pupil expander, and an outcoupler. The first exit pupil expander and the second exit pupil expander each comprises one or more facets. The incoupler is configured to direct display light to the first pupil exit expander. The first exit pupil expander is configured to direct light based on the display light to the second exit pupil expander and to further direct light based on the display light to the outcoupler. The second exit pupil expander is configured to direct light to the outcoupler based on the light directed from the first exit pupil expander.

In at least some embodiments, the first exit pupil expander is configured to direct the light to the second exit pupil expander by splitting, by a first facet of the one or more facets of the first exit pupil expander, the display light into multiple light beams, and directing a first light beam of the multiple light beams to the second exit pupil expander.

In at least some embodiments, the first exit pupil expander is configured to direct the light to the outcoupler by directing, by the first facet, a second light beam of the multiple light beams to a second facet of the one or more facets of the first exit pupil expander, and directing, by the second facet, the second light beam to the outcoupler.

In at least some embodiments, the second facet is configured to split the second light beam into at least a third light beam, and direct the at least third light beam to a third facet of the one or more facets of the first exit pupil expander.

In at least some embodiments, the second exit pupil expander is configured to direct the light to the outcoupler by, splitting, by a first facet of the one or more facets of the second exit pupil expander, the light directed from the first exit pupil expander into a plurality of light beams, directing, by the first facet, a first light beam of the plurality of light beams to the outcoupler, and directing, by the first facet, a second light beam of the plurality of light beams to a second facet of the one or more facets of the second exit pupil expander.

In at least some embodiments, the one or more facets of the first exit pupil expander and the one or more facets of the second exit pupil expander each comprise a partially reflective coating.

In at least some embodiments, two or more facets of the first exit pupil expander the second exit pupil expander, or a combination thereof have a different degree of reflectivity.

In accordance with one aspect, a near-eye display system includes an eyeglasses frame, an ophthalmic lens implementing the waveguide optical combiner described above and herein, and a display source to project display light toward the incoupler.

In accordance with one aspect, a method is disclosed for operating the near-eye display system described above and herein to project display light from the display source toward an eye of a user.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a conventional configuration of a waveguide combiner in which the incoupler (IC) and the exit pupil expander (EPE) are aligned.

FIG. 2 illustrates one example of how implementing an IC-EPE-aligned waveguide combiner in an ophthalmic lens within an eyeglass frame limits the available shapes that the ophthalmic lens can employ.

FIG. 3 illustrates one example of how moving the IC-EPE-aligned waveguide combiner of FIG. 2 can cause the resulting aligned EPE position to “collide” with the ophthalmic lens shape.

FIG. 4 illustrates one example of how increasing the field-of-view provided by the IC-EPE-aligned waveguide combiner of FIG. 2 can lead to a “collision” between the EPE and an outcoupled of the waveguide combiner when the IC is located in the temple of the eyeglass frame.

FIG. 5 illustrates one example of how increasing the field-of-view provided by the IC-EPE-aligned waveguide combiner of FIG. 2 can lead to a “collision” between the EPE and an outcoupled of the waveguide combiner when the IC is located in the bridge of the eyeglass frame.

FIG. 6 illustrates one example of a near-eye display system comprising a waveguide combiner employing multiple EPEs along with a multi-directional IC that reflects light in multiple directions in accordance with at least some embodiments.

FIG. 7 illustrates one configuration of the IC and multiple EPEs employed by the waveguide combiner of FIG. 6 in accordance with at least some embodiments.

FIG. 8 illustrates another configuration of the IC and multiple EPEs employed by the waveguide combiner of FIG. 6 in accordance with at least some embodiments.

FIG. 9 illustrates a further configuration of the IC and multiple EPEs employed by the waveguide combiner of FIG. 6 in accordance with at least some embodiments.

FIG. 10 and FIG. 11 together show a flow diagram illustrating an example method of operating a near-eye display to project display light from a display source toward an eye of a user using the waveguide combiner configuration of FIG. 7 in accordance with some embodiments.

FIG. 12 shows a flow diagram illustrating an example method of operating a near-eye display to project display light from a display source toward an eye of a user using the waveguide combiner configuration of either FIG. 8 or FIG. 9 in accordance with some embodiments.

FIG. 13 shows an example display system with an integrated laser projection system in accordance with some embodiments.

### DETAILED DESCRIPTION

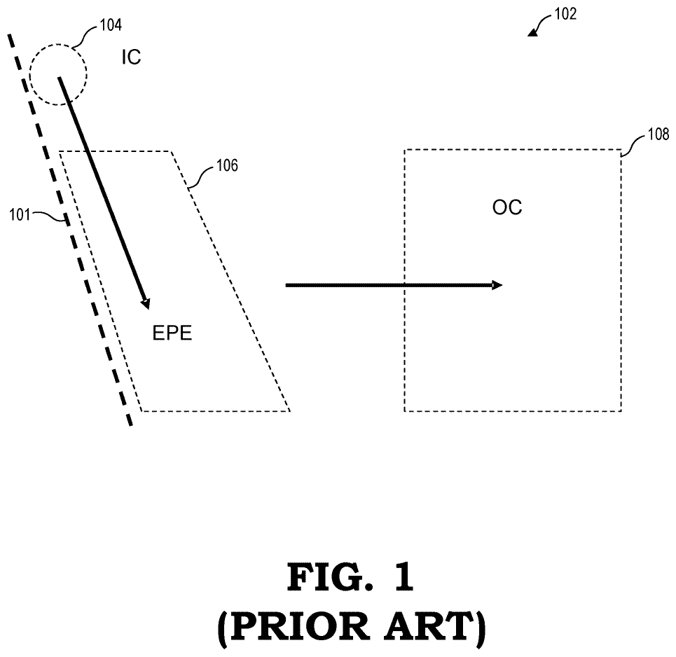

A waveguide combiner is often used in NED devices to provide a view of the real world overlayed with static imagery or video (recorded or rendered). As shown in FIG. 1, a waveguide combiner 102 typically employs an incoupler (IC) 104 to receive display light, an exit pupil expander (EPE) 106 to increase the size of the display exit pupil, and an outcoupler (OC) 108 to direct the resulting display light toward a user's eye. However, as illustrated by FIG. 1, the position of an IC 104 is typically tied to the position of the EPE 106; that is, the IC 104 is aligned with the EPE 106, as represented by the dashed line 101.

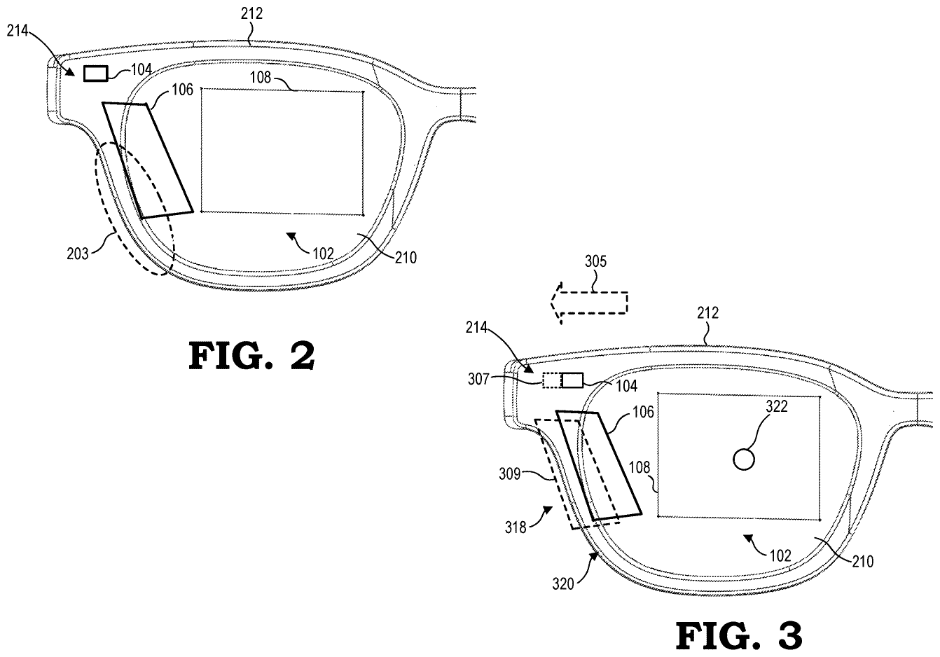

Implementing a single IC-EPE-aligned waveguide combiner in an ophthalmic lens with an eyeglass form factor can limit the available shapes that the ophthalmic lens can employ. For example, FIG. 2 shows an example of an ophthalmic lens 210 housed within an eyeglass-type near-eye display frame 212 (herein referred to as “frame 212” for brevity). It should be understood that only a portion of the frame 212 is shown for clarity. In this example, the waveguide combiner 102 of FIG. 1 is employed within the ophthalmic lens 210 such that IC 104 is situated within a temple region 214 of the frame 212. However, implementing the IC 104 within the temple region 214 typically requires a positioning of the aligned EPE 106 that limits one or both of the size or curvature that can be employed for the region of the ophthalmic lens 210 below the temple 214, as represented by the dashed lines 203. As further shown by FIG. 3, an attempt to move the IC 104 into the temple 214 of the frame 212 (represented by the dashed arrow 305 and dashed lines 307) can cause the resulting aligned EPE position (represented by dashed lines 309) to “collide” with the ophthalmic lens shape. Stated differently, the resulting aligned EPE position 309 extends into a region 318 beyond the edge 320 of the ophthalmic lens 210 and one or both into or beyond the frame 212.

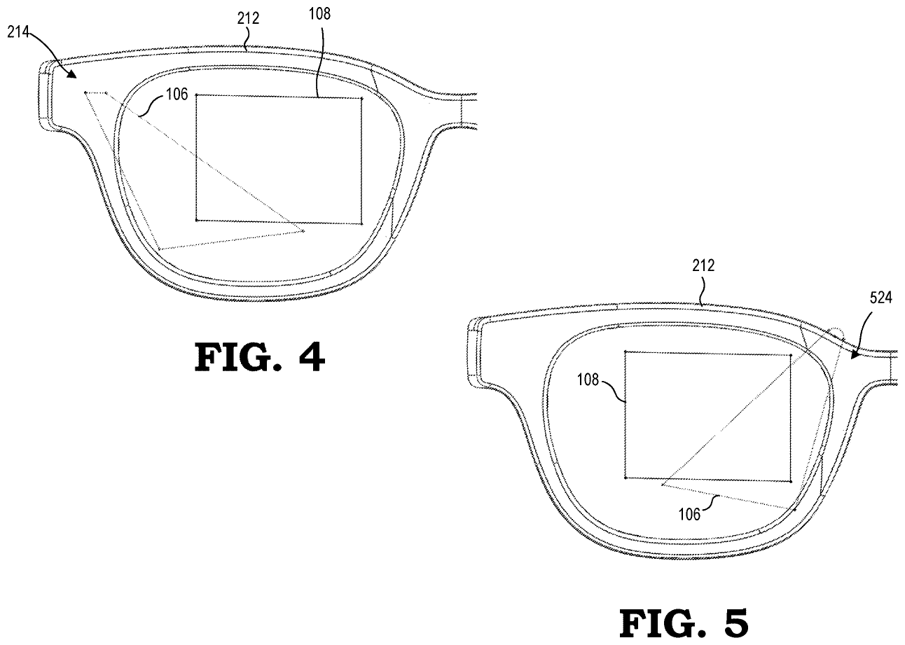

Moreover, a typical IC-EPE-OC alignment in an ophthalmic lens results in a relatively small field of view (FOV) (e.g., often 10°×10° FOV or less), as represented by the small circle 322 within the OC 108 of FIG. 3. When increasing the FOV, the dimensions of the OC 108 and EPE 106 also need to be increased, which can lead to a “collision” between the EPE 106 and OC 108 as shown in FIG. 4 and FIG. 5. Stated differently, the EPE 106 and OC 108 have an impractical amount of overlap, regardless of whether the IC 104 is located in the temple 214 (FIG. 5) or the bridge 524 (FIG. 5) of the frame 212.

As such, implementing a single EPE along with the particular IC-EPE alignment impacts the positioning of the IC-EPE in a near-eye display with an eyeglass form factor in a way that either requires unfavorable positioning of the IC outside of the temple, limits one or both of the shape or size of the ophthalmic lens implementing the waveguide combiner, or results in an unfavorable FOV for the OC. Accordingly, described herein are example waveguide combiner configurations/architectures that overcome the positioning, shape, and size limitations of conventional waveguide combiners described above. As described in greater detail below, one or more embodiments implement a waveguide combiner within an ophthalmic lens that facilitates a wider FOV and more favorable IC positioning by employing multiple EPEs along with a multi-directional IC that reflects light in multiple directions (e.g., in the same number of directions as the number of EPEs). For example, the waveguide combiner includes an IC, a plurality of EPEs, and an OC. The IC is configured to split incoming display light into multiple light beams. Each of the EPEs includes one or more facets configured to receive a corresponding light beam of the multiple light beams and to output light towards the OC based on the received corresponding light beam.

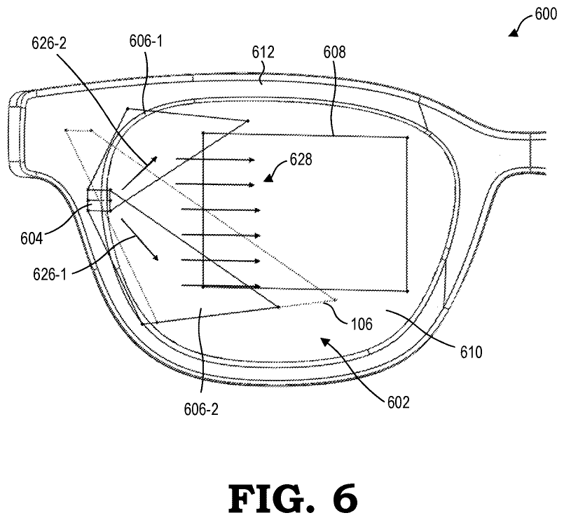

FIG. 6 illustrates a near-eye display system 600 (herein referred to as “display system 600”) capable of implementing the waveguide combiner configurations described herein. In this example, the display system 600 is implemented in an eyeglass-type near-eye display frame 612 (herein referred to as “frame 612”) comprising an ophthalmic lens 610. It should be understood that other configurations of the display system 600 are applicable as well. It should also be understood that only a portion of the frame 612 is shown for clarity.

The display system 600 comprises a waveguide combiner 602 implemented within the ophthalmic lens 610. The waveguide combiner 602 includes at least two EPEs 606 (illustrated as EPE 606-1 and EPE 606-2) and an IC 604, which is a multi-direction (e.g., bi-directional) IC, that reflects input display light 626 (illustrated as display light 626-1 and display light 626-2 from a display source, not shown) in multiple directions (e.g., at least two directions), one direction toward a top EPE 606-1 and another direction toward a bottom EPE 606-2. The multiple EPEs 606 then direct their expanded display light 628 toward the OC 608, which in turn redirects the input light from the EPEs 606 towards the user's eye. FIG. 6 further illustrates a size and position of a conventional EPE 106 for comparison purposes.

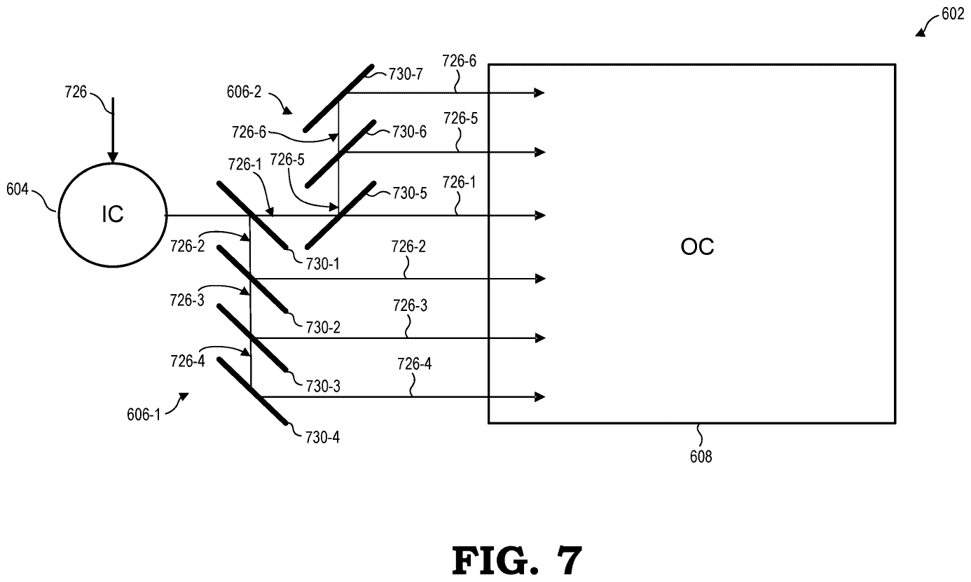

In at least some embodiments, each EPE 606 in this multiple-EPE configuration is implemented as a series or sequence of reflective facets 730 with partial reflective coatings, as shown in FIG. 7. For example, FIG. 7 shows the first EPE 606-1 comprises a sequence of four reflective facets 730 (illustrated as facets 730-1 to 730-4) and the second EPE 606-2 comprises a sequence of three reflective facets 730 (illustrated as facets 730-5 to 730-7). However, it should be understood that each of the EPEs 606 can have the same number of reflective facets 730 or a different number of reflective facets 730 (e.g., one or more facets 730) than what is shown in FIG. 7. It should also be noted that although the reflective facets 730 are illustrated in FIG. 7 as being in-plane for ease of illustration, in at least some embodiments, some or all of the facets 730 can fold out-of-plane (that is, out of the “page”). In at least some embodiments, the reflective facets 730 are implemented as partially reflective mirrors, and each partially reflective mirror can have its own distinct performance specification (e.g., the degree of reflectivity can vary between facets).

The first EPE 606-1 and the second EPE 606-2, in at least some embodiments, are offset or staggered relative to each other.

In the example shown in FIG. 7, the IC 604 of the waveguide combiner 602 receives display light 726 from a display source (not shown). The IC 604 reflects the display light 726 to a first facet 730-1 of the first EPE 606-1. The first facet 730-1 is configured such that the incident display light 726 is split into multiple light beams, including light beam 726-1 and light beam 726-2. The first facet 730-1 is further configured such that one of the light beams 726-1 passes through the first facet 730-1 of the first EPE 606-1 to a first facet 730-5 of the second EPE 606-2, and another light beam 726-2 is reflected to a second facet 730-2 of the first EPE 606-1 (or vice versa). The second facet 730-2 is configured such that the incident light beam 726-2 from the first facet 730-1 is split into at least one other light beam, including light beam 726-3. The second facet 730-2 is further configured such that one of the light beams 726-2 is reflected towards the OC 608, and the other light beam 726-3 passes through to a third facet 730-3 of the first EPE 606-1 (or vice versa). The third facet 730-3 is configured such that the incident light beam 726-3 from the second facet 730-2 is split into at least one additional light beam, including light beam 726-4. The third facet 730-3 is further configured such that one of the light beams 726-3 is reflected towards the OC 608, and the additional light beam 726-4 passes through to a fourth facet 730-4 of the first EPE 606-1 (or vice versa). The fourth facet 730-4 is configured such that the incident light beam 726-4 from the third facet 730-3 is reflected to the OC 608.

The first facet 730-5 of the second EPE 606-2 is configured such that the incident light beam 726-1 from the first facet 730-1 of the first EPE 606-1 is split into at least one other light beam, including light beam 726-5. The first facet 730-5 is further configured such that one of the light beams 726-1 passes through to the OC 608, and the other light beam 726-5 is reflected to a second facet 730-6 of the second EPE 606-2 (or vice versa). The second facet 730-6 is configured such that the incident light beam 726-5 from the first facet 730-5 is split into at least one additional light beam, including light beam 726-6. The second facet 730-6 is further configured such that one of the light beams 726-5 is reflected towards the OC 608, and the additional light beam 726-6 passes through to a third facet 730-7 of the second EPE 606-2 (or vice versa). The third facet 730-7 is configured such that the incident light beam 726-6 from the second facet 730-6 is reflected to the OC 608.

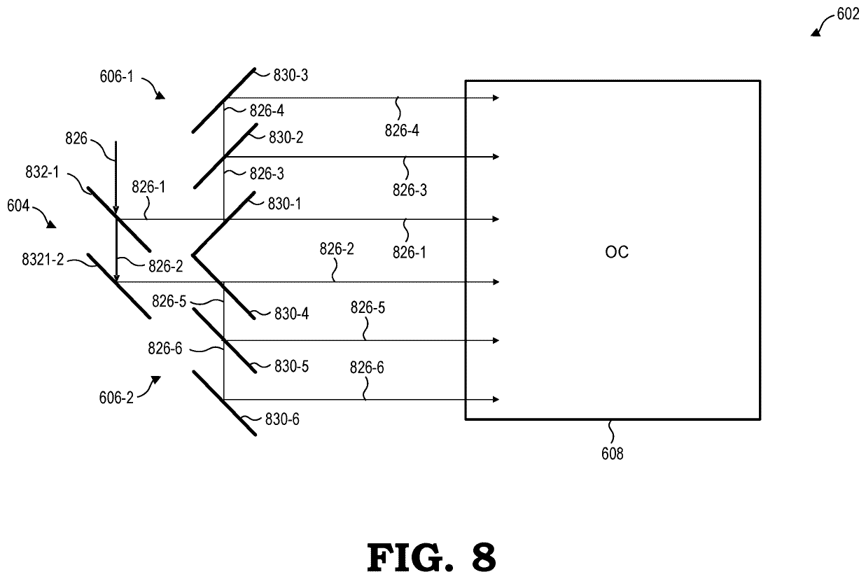

In at least some embodiments, the multi-directional IC 604 is implemented as a faceted IC with a plurality of partially-reflective mirrors. For example, FIG. 8 shows an example implementation in which the multi-directional IC 604 of the waveguide combiner 602 is implemented as a faceted IC with two partially-reflective mirrors 832 (illustrated as mirror 832-1 and mirror 832-2). In at least some embodiments, each partially reflective mirror 832 has its own distinct performance specification (e.g., the degree of reflectivity can vary between facets). It should be understood that although FIG. 8 only shows two partially-reflective mirrors 832, more than two partially-reflective mirrors 832 can be used to implement the multi-directional IC 604.

In the example shown in FIG. 8, the waveguide 602 also comprises a multiple-EPE configuration in which the first EPE 606-1 comprises a sequence of three reflective facets 830 (illustrated as facets 830-1 to 830-3) and the second EPE 606-2 also includes a sequence of three reflective facets 830 (illustrated as facets 830-4 to 830-6). However, it should be understood that each of the EPEs 606 can have a different number of reflective facets 830 (e.g., one or more facets 830) than what is shown in FIG. 8. It should also be noted that although the reflective facets 830 are illustrated in FIG. 8 as being in-plane for ease of illustration, in at least some embodiments, some or all of the facets 830 can fold out-of-plane (that is, out of the “page”). In at least some embodiments, the reflective facets 830 are implemented as partially reflective mirrors, and each partially reflective mirror can have its own distinct performance specification (e.g., the degree of reflectivity can vary between facets). The first EPE 606-1 and the second EPE 606-2, in at least some embodiments, are aligned (e.g., not offset) with each other.

In the example shown in FIG. 8, the IC 604 splits display light 826 from a display source (not shown) into multiple light beams, including light beam 826-1 and light beam 826-2. For example, a first mirror 832-1 of the IC 604 receives display light 826 from a display source (not shown). In at least some embodiments, each partially-reflective mirror 832 is configured to reflect a corresponding incident portion of the display light to a corresponding receiving facet 830 of one of the two EPEs 606. For example, the first mirror 832-1 of the IC 604 reflects a first light beam 826-1 of the display light 826 to a first facet 830-1 of the first EPE 606-1 and passes a second light beam 826-2 of the display light 826 to the second mirror 832-2 of the IC 604. The first facet 830-1 of the first EPE 606-1 is configured such that the incident light beam 826-1 from the first mirror 832-1 is split into at least one other light beam, including light beam 826-3. The first facet 830-1 is further configured such that one of the light beams 826-1 passes through the first facet 830-1 and is directed towards the OC 608, and the other light beam 826-3 is reflected to a second facet 830-2 of the first EPE 606-1 (or vice versa). The second facet 830-2 is configured such that the incident light beam 826-3 from the first facet 830-1 is split into at least one additional light beam, including light beam 826-4. The second facet 830-2 is further configured such that one of the light beams 826-3 is reflected towards the OC 608, and the additional light beam 826-4 passes through to a third facet 830-3 of the first EPE 606-1 (or vice versa). The third facet 830-3 is configured such that the incident light beam 826-4 from the second facet 830-2 is reflected to the OC 608.

The second light beam 826-2 that passes through the first mirror 832-1 of the IC 604 to the second mirror 832-2 of the IC 604 is reflected by the second mirror 832-1 to a first facet 830-4 of the second EPE 606-2. The first facet 830-4 of the second EPE 606-2 is configured such that the incident light beam 826-2 from the second mirror 832-2 is split into at least one other light beam, including light beam 826-5. The first facet 830-4 is further configured such that one of the light beams 826-2 passes through the second facet 830-4 and is directed towards the OC 608, and the other light beam 826-5 is reflected to a second facet 830-5 of the second EPE 606-2 (or vice versa). The second facet 830-5 is configured such that the incident light beam 826-5 from the first facet 830-4 is split into at least one additional light beam, including light beam 826-6. The second facet 830-5 is further configured such that one of the light beams 826-5 is reflected towards the OC 608, and the additional light beam 826-6 passes through to a third facet 830-6 of the second EPE 606-2 (or vice versa). The third facet 830-6 is configured such that the incident light beam 826-6 from the second facet 830-5 is reflected to the OC 608.

In at least some embodiments, the multi-directional IC 604 is implemented as a polarizing beam splitter, a reflective mirror, and a half-wave plate. This configuration allows unpolarized input display light to be separated into different polarizations such that portions of the input display light having a first polarization travel in one direction and portions of the display light having a second polarization travel in the other direction. The display light having the second polarization is then converted to be first polarization so that all light directed from the EPEs 606 is received by the OC 608 with the same polarization state.

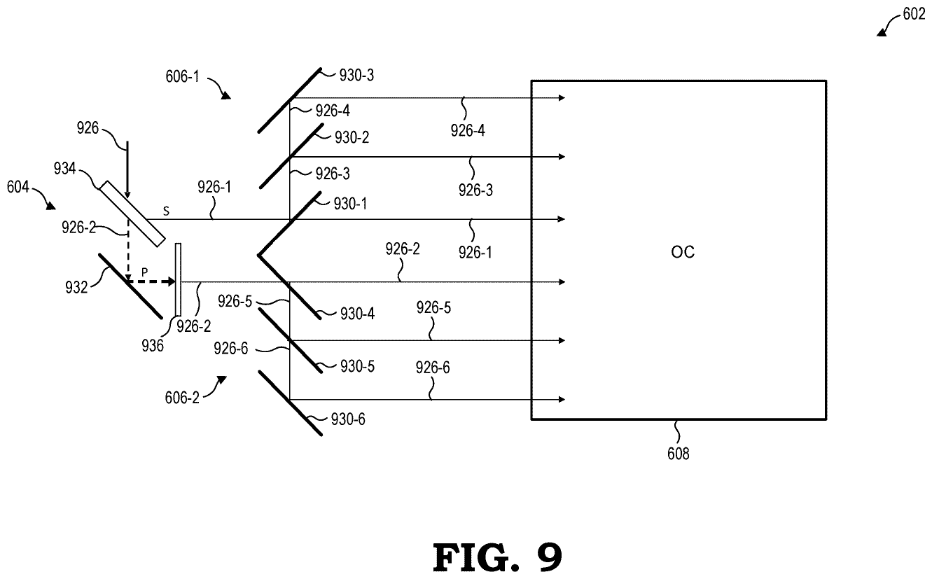

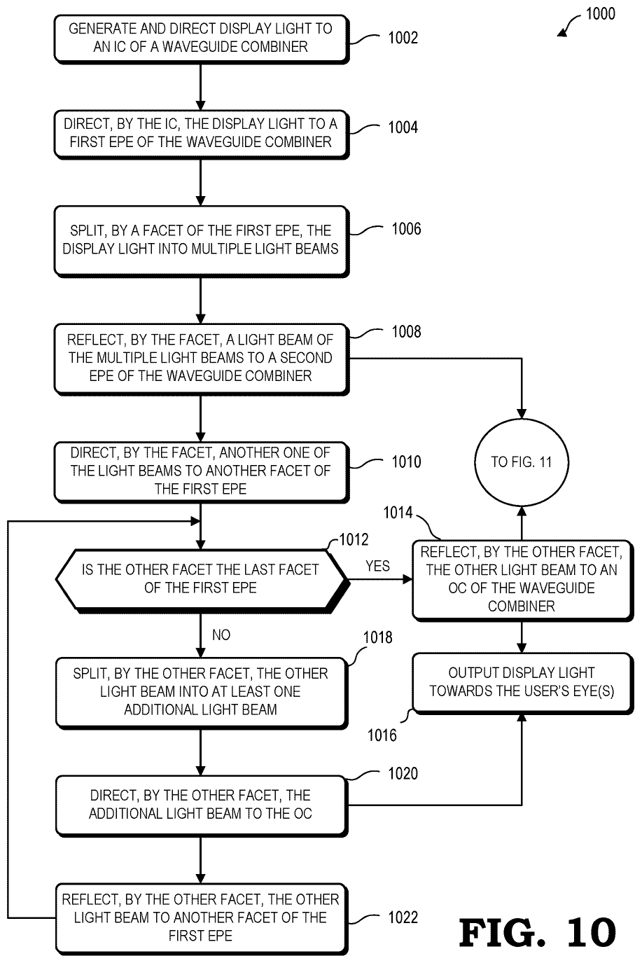

For example, FIG. 9 shows an example implementation in which the multi-directional IC 604 of the waveguide combiner 602 is implemented as a polarizing beam splitter (PBS) 934, a reflective mirror (or partially reflective mirror) 932, and a half-wave plate 936. In the example shown in FIG. 9, the waveguide 602 also comprises a multiple-EPE configuration in which the first EPE 606-1 comprises a sequence of three reflective facets 930 (illustrated as facets 930-1 to 930-3) and the second EPE 606-2 also includes a sequence of three reflective facets 930 (illustrated as facets 930-4 to 930-6). However, it should be understood that each of the EPEs 606 can have a different number of reflective facets 930 (e.g., one or more facets 930) than what is shown in FIG. 9. It should also be noted that although the reflective facets 930 are illustrated in FIG. 9 as being in-plane for ease of illustration, in at least some embodiments, some or all of the facets 930 can fold out-of-plane (that is, out of the “page”). In at least some embodiments, the reflective facets 930 are implemented as partially reflective mirrors, and each partially reflective mirror can have its own distinct performance specification (e.g., the degree of reflectivity can vary between facets). The first EPE 606-1 and the second EPE 606-2, in at least some embodiments, are aligned (e.g., not offset) with each other.

In the example shown in FIG. 9, the IC 604 splits display light 926 from a display source (not shown) into multiple light beams, including light beam 926-1 and light beam 926-2. For example, the PBS 934 receives display light 926 from a display source (not shown) and generates at least two polarized light beams, including an S-polarized light beam 926-1 and a P-polarized light beam 926-2. In at least some embodiments, the PBS 934 is configured to direct the S-polarized light beam 926-1 toward the first facet 930-1 of the first EPE 606-1 and direct the P-polarized light 926-2 to the reflective mirror 932 of the IC 604. The first facet 930-1 of the first EPE 606-1 is configured such that the incident light beam 926-1 from the first PBS 934 is split into at least one other light beam, including light beam 926-3. The first facet 930-1 is further configured such that one of the light beams 926-1 passes through the first facet 930-1 and is directed towards the OC 608, and the other light beam 926-3 is reflected to a second facet 930-2 of the first EPE 606-1 (or vice versa). The second facet 930-2 is configured such that the incident light beam 926-3 from the first facet 930-1 is split into at least one additional light beam, including light beam 926-4. The second facet 930-2 is further configured such that one of the light beams 926-3 is reflected towards the OC 608, and the additional light beam 926-4 passes through to a third facet 930-3 of the first EPE 606-1 (or vice versa). The third facet 930-3 is configured such that the incident light beam 926-4 from the second facet 830-2 is reflected to the OC 608.

The P-polarized light beam 926-2 is reflected off the reflective mirror 932 of the IC 604. The reflected P-polarized light beam 926-2 passes through the half-wave plate 936, which converts the incident light from a P-polarization light beam 926-2 to an S-polarized light beam 926-2. The S-polarized light beam 926-2 is received by a first facet 930-4 of the second EPE 606-2. The first facet 930-4 of the second EPE 606-2 is configured such that the incident light beam 926-2 from the half-wave plate 936 is split into at least one other light beam, including light beam 926-5. The first facet 930-4 is further configured such that one of the light beams 926-2 passes through the second facet 930-4 and is directed towards the OC 608, and the other light beam 926-5 is reflected to a second facet 930-5 of the second EPE 606-2 (or vice versa). The second facet 930-5 is configured such that the incident light beam 926-5 from the first facet 930-4 is split into at least one additional light beam, including light beam 926-6. The second facet 930-5 is further configured such that one of the light beams 926-5 is reflected towards the OC 608, and the additional light beam 926-6 passes through to a third facet 830-6 of the second EPE 606-2 (or vice versa). The third facet 930-6 is configured such that the incident light beam 926-6 from the second facet 930-5 is reflected to the OC 608. Thus, in this approach, the light reflected from each of the two EPEs 606 is S-polarized, and all light from the EPEs 606 into the OC 608 has the same polarization state.

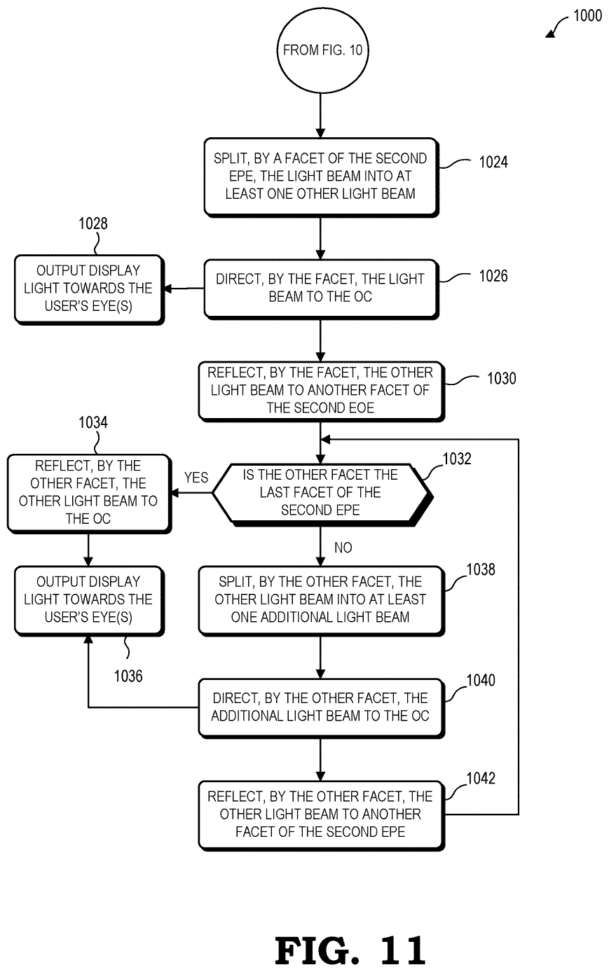

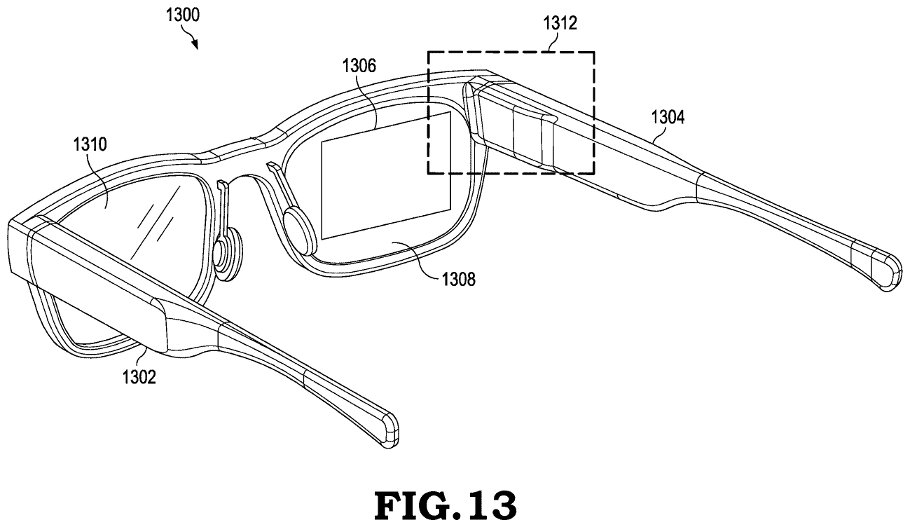

FIG. 10 and FIG. 11 together illustrate, in flow chart form, one example method 1100 of operating a near-eye display, such as the system 600 of FIG. 6 to FIG. 9 or the system 1300 of FIG. 13, to project display light from a display source toward an eye of a user. The method 1000 is not limited to the sequence of operations shown in FIG. 10 and FIG. 11, as at least some of the operations can be performed in parallel or in a different sequence. Moreover, in at least some embodiments, the method 1000 can include one or more different operations than those shown in FIG. 10 and FIG. 11.

At block 1002, a display source generates and directs display light 726 to an IC 604 of a waveguide combiner 602. At block 1004, the IC 604 directs the display light 726 to a first EPE 606-1 of the waveguide combiner 602. At block 1006, a facet 730-1 of the first EPE 606-1 splits the display light 726 into multiple light beams. At block 1008, the facet 730-1 reflects a light beam 726-1 of the multiple light beams to a second EPE 606-2 of the waveguide combiner 602. The method 1000 proceeds to FIG. 11 where, in at least some embodiments, the second EPE 606-2 performs the processes/operations at blocks 1024 to 1042 concurrently with the processes/operations performed by the first EPE 606-1 at blocks 1010 to 1022. The method proceeds to block 1010 where the facet of the first EPE 606-1 directs another light beam 726-2 of the multiple light beams to another facet 730-2 of the first EPE 606-1.

At block 1012, if the other facet 730-2 is the last facet of the first EPE 606-1, the method 1000 proceeds to block 1014, and the other facet 730-2 reflects the other light beam 726-2 to an OC 608 of the waveguide combiner 602. At block 1016, the OC 608 outputs the received display light toward the eye(s) of the user. At block 1012, if the other facet 730-2 is not the last facet of the first EPE 606-1, the method 1000 proceeds to block 1018, and the other facet 730-2 splits the other light beam 726-2 into at least one additional light beam 726-3. At block 1020, the other facet 730-2 reflects or directs the other light beam 726-2 (or the additional light beam 726-3) to the OC 608. At block 1016, the OC 608 outputs the received display light toward the eye(s) of the user. At block 1022, the other facet 730-2 reflects or directs the additional light beam 726-3 (or the other light beam 726-2) to another facet 730-3 of the first EPE 606-1, and the method returns to block 1012.

Referring now to FIG. 11, at block 1024, a facet 730-5 of the second EPE 606-2 splits the light beam 726-1, which was reflected by the facet 730-1 of the first EPE 606-1, into at least one other light beam 726-5. At block 1026, the facet 730-5 reflects or directs the light beam 726-1 (or the other light beam 726-5) to the OC 608. At block 1028, the OC 608 outputs the received display light toward the eye(s) of the user. At block 1030, the facet 730-5 reflects or directs the other light beam 726-5 (or the light beam 726-1) to another facet 730-6 of the second EPE 606-2. At block 1032, if the other facet 730-6 is the last facet of the second EPE 606-2, the method 1000 proceeds to block 1034, and the other facet 730-6 reflects or directs the other light beam 726-5 (or the light beam 726-1) to the OC 608. At block 1036, the OC 608 outputs the received display light toward the eye(s) of the user.

At block 1032, if the other facet 730-6 is not the last facet of the second EPE 606-2, the method 1000 proceeds to block 1038, and the other facet 730-6 splits the other light beam 726-5 (or the light beam 726-1) into at least one additional light beam 726-6. At block 1040, the other facet 730-6 reflects or directs the other light beam 726-5 (or the additional light beam 726-6) to the OC 608. At block 1036, the OC 608 outputs the received display light toward the eye(s) of the user. At block 1042, the other facet 730-6 reflects or directs the additional light beam 726-6 (or the other light beam 726-5) to another facet 730-6 of the second EPE 606-2, and the method returns to block 1032.

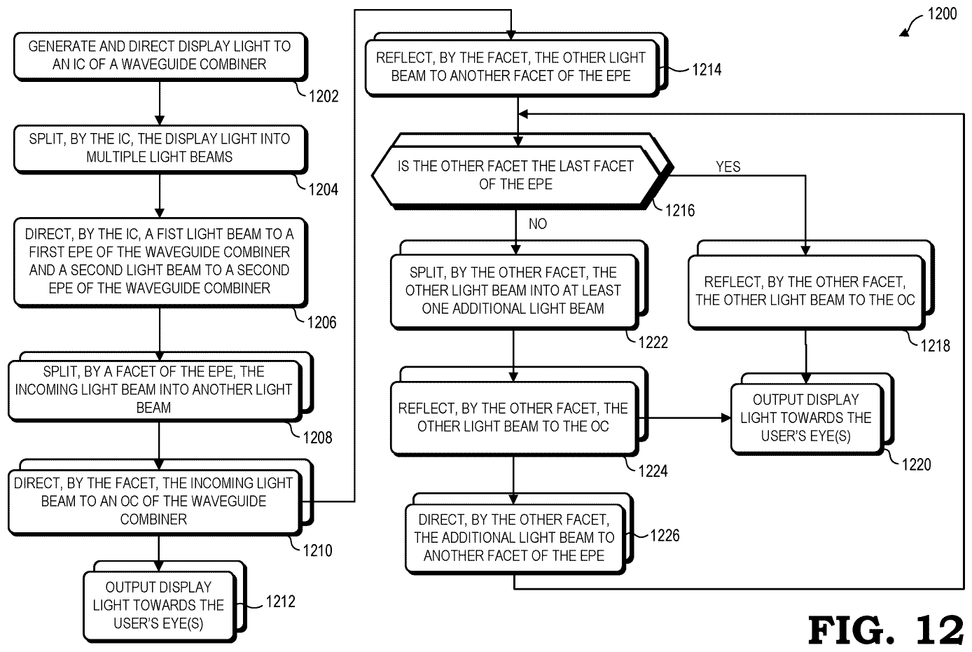

FIG. 12 illustrates, in flow chart form, another example method 1200 of operating a near-eye display, such as the system 600 of FIG. 6 to FIG. 9 or the system 1300 of FIG. 13, to project display light from a display source toward an eye of a user. The method 1200 is not limited to the sequence of operations shown in FIG. 12, as at least some of the operations can be performed in parallel or in a different sequence. Moreover, in at least some embodiments, the method 1200 can include one or more different operations than those shown in FIG. 12.

At block 1202, a display source generates and directs display light 826 to an IC 604 of a waveguide combiner 602. At block 1204, the IC 604 splits the display light 826 into multiple light beams (e.g., light beams 826-1 and 826-2 or polarized light beams 926-1 and 926-2) as described above with respect to FIG. 8 or FIG. 9. At block 1206, the IC 604 reflects or directs a first light beam 826-1 to a first EPE 606-1 of the waveguide combiner 602 and directs a second light beam 826-2 to a second EPE 606-2 of the waveguide combiner 602 as described above with respect to FIG. 8 or FIG. 9. The processes/operations at block 1208 to block 1226 are then performed concurrently for each of the EPEs 606, as represented by the double blocks. For example, at block 1208 a facet 830-1 of the first EPE 606-1 splits the incoming light beam 826-1 into another light beam 826-3. At block 1210, the facet 830-1 reflects or directs the incoming light beam 826-1 (or the other light beam 826-3) to an OC 608 of the waveguide combiner 602. At block 1212, the OC 608 outputs the received display light toward the eye(s) of the user.

At block 1214, the facet 830-1 reflects or directs the other light beam 826-3 (or light beam 826-1) to another facet 830-2 of the first EPE 606-1. At block 1216, if the other facet 830-2 is the last facet of the first EPE 606, the method 1200 proceeds to block 1218, and the other facet 830-2 reflects or directs the other light beam 826-3 (or light beam 826-1) to the OC 608. At block 1220, the OC 608 outputs the received display light toward the eye(s) of the user. At block 1216, if the other facet 830-2 is not the last facet of the EPE 606, the method 1200 proceeds to block 1222, and the other facet 830-2 splits the other light beam 826-3 (or light beam 826-1) into at least one additional light beam 826-4. At block 1224, the other facet 830-2 reflects or directs the other light beam 826-3 (or the additional light beam 826-4) to the OC 608. At block 1220, the OC 608 outputs the received display light toward the eye(s) of the user. At block 1226, the other facet 830-2 reflects or directs the additional light beam 826-4 (or the other light beam 826-3) to another facet 830-3 of the EPE 606, and the method returns to block 1216. Similar processes are concurrently performed for the second EPE 606-2.

FIG. 13 illustrates an example display system 1300 capable of implementing one or more of the waveguide combiner configurations described herein. It should be noted that, although the apparatuses and techniques described herein are not limited to this particular example, but instead may be implemented in any of a variety of display systems using the guidelines provided herein. In at least some embodiments, the display system 1300 comprises a support structure 1302 that includes an arm 1304, which houses an image source, such as laser projection system, configured to project images toward the eye of a user such that the user perceives the projected images as being displayed in a field of view (FOV) area 1306 of a display at one or both of lens elements 1308, 1310. In the depicted embodiment, the display system 1300 is a near-eye display system that includes the support structure 1302 configured to be worn on the head of a user and has a general shape and appearance of an eyeglasses frame. The support structure 1302 includes various components to facilitate the projection of such images toward the eye of the user, such as a laser projector, an optical scanner, and a waveguide combiner, such as the waveguide combiner 602 described above with respect to FIG. 6 to FIG. 12. In at least some embodiments, the support structure 1302 further includes various sensors, such as one or more front-facing cameras, rear-facing cameras, other light sensors, motion sensors, accelerometers, and the like. The support structure 1302 further can include one or more radio frequency (RF) interfaces or other wireless interfaces, such as a Bluetooth(TM) interface, a Wireless Fidelity (WiFi) interface, and the like.

Further, in at least some embodiments, the support structure 1302 includes one or more batteries or other portable power sources for supplying power to the electrical components of the display system 1300. In at least some embodiments, some or all of these components of the display system 1300 are fully or partially contained within an inner volume of support structure 1302, such as within the arm 1304 in region 1312 of the support structure 1302. It should be noted that while an example form factor is depicted, it will be appreciated that in other embodiments, the display system 1300 may have a different shape and appearance from the eyeglasses frame depicted in FIG. 13.

One or both of the lens elements 1308, 1310 are used by the display system 1300 to provide an augmented reality (AR) or a mixed reality (MR) display in which rendered graphical content is superimposed over or otherwise provided in conjunction with a real-world view as perceived by the user through the lens elements 1308, 1310. For example, laser light used to form a perceptible image or series of images may be projected by a laser projector of the display system 1300 onto the eye of the user via a series of optical elements, such as a waveguide (e.g., the waveguide combiner 200) formed at least partially in the corresponding lens element, one or more scan mirrors, and one or more optical relays. Thus, one or both of the lens elements 1308, 1310 include at least a portion of a waveguide that routes display light received by an input coupler, or multiple input couplers, of the waveguide to an output coupler of the waveguide, which outputs the display light toward an eye of a user of the display system 1300. The display light is modulated and scanned onto the eye of the user such that the user perceives the display light as an image. In addition, each of the lens elements 1308, 1310 is sufficiently transparent to allow a user to see through the lens elements to provide a field of view of the user's real-world environment such that the image appears superimposed over at least a portion of the real-world environment.

In at least some embodiments, the projector is a matrix-based projector, a digital light processing-based projector, a scanning laser projector, or any combination of a modulative light source such as a laser or one or more light-emitting diodes (LEDs) and a dynamic reflector mechanism such as one or more dynamic scanners or digital light processors. The projector, in at least some embodiments, includes multiple laser diodes (e.g., a red laser diode, a green laser diode, and a blue laser diode) and at least one scan mirror (e.g., two one-dimensional scan mirrors, which may be micro-electromechanical system (MEMS)-based or piezo-based). The projector is communicatively coupled to the controller and a non-transitory processor-readable storage medium or memory storing processor-executable instructions and other data that, when executed by the controller, cause the controller to control the operation of the projector. In at least some embodiments, the controller controls a scan area size and scan area location for the projector and is communicatively coupled to a processor (not shown) that generates content to be displayed at the display system 1300. The projector scans light over a variable area, designated the FOV area 1306, of the display system 1300. The scan area size corresponds to the size of the FOV area 1306, and the scan area location corresponds to a region of one of the lens elements 1308, 1310 at which the FOV area 1306 is visible to the user. Generally, it is desirable for a display to have a wide FOV to accommodate the outcoupling of light across a wide range of angles. The range of different user eye positions that will be able to see the display is referred to as the eyebox of the display.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A waveguide combiner comprising:
an incoupler configured to split incoming display light into multiple light beams;
an outcoupler; and
a plurality of exit pupil expanders each exit pupil expander of the plurality of exit pupil expanders comprising one or more facets configured to receive a corresponding light beam of the multiple light beams and to output light towards the outcoupler based on the received corresponding light beam.

2. The waveguide combiner of claim 1, wherein the one or more facets each comprise a partially reflective coating.

3. The waveguide combiner of claim 1, wherein the incoupler comprises a plurality of partially reflective mirrors each partially reflective mirror of the plurality of partially reflective mirrors is configured to generate one light beam of the multiple light beams.

4. The waveguide combiner of claim 3, wherein a first partially reflective mirror of the plurality of partially reflective mirrors is configured to reflect a first light beam of the multiple light beams to a first exit pupil expander of the plurality of exit pupil expanders.

5. The waveguide combiner of claim 4, wherein a first partially reflective mirror of the plurality of partially reflective mirrors is configured to direct a second light beam of the multiple light beams to a second partially reflective mirror of the plurality of partially reflective mirrors.

6. The waveguide combiner of claim 5, wherein the partially reflective mirror of the plurality of partially reflective mirrors is configured to reflect the second light beam to a second exit pupil expander of the plurality of exit pupil expanders.

7. The waveguide combiner of claim 1, wherein a first exit pupil expander of the plurality of exit pupil expanders comprises a first facet configured to:
split the corresponding light beam received by the first exit pupil expander into a first light beam and a second light beam
direct the first light beam to the outcoupler; and
direct the second light beam to a second facet of the first exit pupil expander.

8. The waveguide combiner of claim 7, wherein a second exit pupil expander of the plurality of exit pupil expanders comprises a first facet configured to:
split the corresponding light beam received by the second exit pupil expander into a third light beam and a fourth light beam
direct the third light beam to the outcoupler; and
direct the fourth light beam to a second facet of the second exit pupil expander.

9. The waveguide combiner of claim 1, wherein the incoupler comprises:
a polarizing beam splitter configured to generate a first light beam of the multiple light beams having a first polarization;
a mirror configured to generate a second light beam of the multiple light beams having a second polarization; and
a half-wave plate configured to convert the second polarization of the second light beam to the first polarization.

10. The waveguide combiner of claim 9, wherein:
the polarizing beam splitter is configured to direct the first light beam to a first exit pupil expander of the plurality of exit pupil expanders;
the mirror is configured to direct the second light beam to the half-wave plate; and
the half-wave plate is configured to direct the second light beam to a second exit pupil expander of the plurality of exit pupil expanders.

11. The waveguide combiner of claim 9, wherein the first polarization is an S-polarization and the second polarization is a P-polarization.

12. A waveguide combiner comprising:
an incoupler;
a first exit pupil expander comprising one or more facets;
a second exit pupil expander comprising one or more facets; and
an outcoupler,
the incoupler configured to direct display light to the first pupil exit expander;
the first exit pupil expander configured to direct light based on the display light to the second exit pupil expander and to further direct light based on the display light to the outcoupler; and
the second exit pupil expander configured to direct light to the outcoupler based on the light directed from the first exit pupil expander.

13. The waveguide combiner of claim 12, wherein the first exit pupil expander is configured to direct the light to the second exit pupil expander by:
splitting, by a first facet of the one or more facets of the first exit pupil expander, the display light into multiple light beams; and
directing a first light beam of the multiple light beams to the second exit pupil expander.

14. The waveguide combiner of claim 12, wherein the first exit pupil expander is configured to direct the light to the outcoupler by:
directing, by the first facet, a second light beam of the multiple light beams to a second facet of the one or more facets of the first exit pupil expander; and
directing, by the second facet, the second light beam to the outcoupler.

15. The waveguide combiner of claim 14, wherein the second facet is configured to:
split the second light beam into at least a third light beam and
direct the at least third light beam to a third facet of the one or more facets of the first exit pupil expander.

16. The waveguide combiner of claim 12, wherein the second exit pupil expander is configured to direct the light to the outcoupler by:
splitting, by a first facet of the one or more facets of the second exit pupil expander, the light directed from the first exit pupil expander into a plurality of light beams;
directing, by the first facet, a first light beam of the plurality of light beams to the outcoupler; and
directing, by the first facet, a second light beam of the plurality of light beams to a second facet of the one or more facets of the second exit pupil expander.

17. The waveguide combiner of claim 12, wherein the one or more facets of the first exit pupil expander and the one or more facets of the second exit pupil expander each comprise a partially reflective coating.

18. The waveguide combiner of claim 12, wherein two or more facets of the first exit pupil expander the second exit pupil expander, or a combination thereof have a different degree of reflectivity.

19. A near-eye display system comprising:
an eyeglasses frame;
an ophthalmic lens comprising a waveguide optical combiner comprising:
an incoupler configured to split incoming display light into multiple light beams;
an outcoupler; and
a plurality of exit pupil expanders, each exit pupil expander of the plurality of exit pupil expanders comprising one or more facets configured to receive a corresponding light beam of the multiple light beams and to output light towards the outcoupler based on the received corresponding light beam; and
a display source to project display light toward the incoupler.

20. The near-eye display system of claim 19, wherein a first exit pupil expander of the plurality of exit pupil expanders is configured to direct the display light to a second exit pupil expander of the plurality of exit pupil expanders by:
splitting, by a first facet of the one or more facets of the first exit pupil expander, the display light into multiple light beams; and
directing a first light beam of the multiple light beams to the second exit pupil expander.
